(19) United States
(12) Patent Application Publication
(10) Pub. No.: US 2011/0145452 A1
(43) Pub. Date: Jun. 16, 2011

(54) METHODS AND APPARATUS FOR DISTRIBUTION OF RAID STORAGE MANAGEMENT OVER A SAS DOMAIN

(75) Inventors: Jason B. Schilling, Colorado Springs, CO (US); Joshua P. Sinykin, Shrewsbury, MA (US)

(73) Assignee: LSI CORPORATION, Milpitas, CA (US)

(21) Appl. No.: 12/639,853

(22) Filed: Dec. 16, 2009

(51) Int. Cl. G06F 13/00; G06F 13/38

(52) U.S. Cl. 710/74; 710/300

(57) ABSTRACT

Methods and apparatus for distributing Redundant Array of Independent Disks (RAID) storage management to one or more Serial Attached SCSI (SAS) expanders in a SAS domain. A RAID set comprises a set of one or more SAS expanders coupled to communicate with one another to process I/O requests directed to a RAID logical volume of the RAID set. The RAID logical volume is distributed over portions of each of multiple storage devices. Each SAS expander of the RAID set is coupled to one or more of the multiple storage devices. Each SAS expander of the RAID set processes a corresponding portion of a received I/O request directed to the RAID logical volume. A master SAS expander of the RAID set receives and aggregates the status information from each of the SAS expanders of the RAID set and returns a completion status to the requesting SAS initiator.

### BACKGROUND

1. Field of the Invention

The invention relates generally to storage management and more specifically relates to methods and apparatus for distributing storage management over Serial Attached SCSI (SAS) expanders in a SAS domain.

2. Discussion of Related Art

Redundant Array of Independent Disks (RAID) storage management is a popular structure and methodology for storage systems to improve reliability and performance as compared to a single disk drive. If a single disk drive fails, the information stored thereon is inaccessible if not irrevocably lost. RAID storage management distributes data over a plurality of independent disk drives and provides various forms of redundancy. The added redundancy assures that the failure of any single disk drive does not render the data of the failed drive inaccessible and assures that data on the failed drive may be recovered from the remaining operating drives. Further, RAID storage systems improve performance as compared to a single disk drive in that relatively large I/O operations may be distributed over multiple simultaneously operable disk drives in the RAID configuration to reduce the total elapsed time for completion.

RAID storage subsystems include not only a plurality of storage devices (e.g., disk drive) but also include a RAID storage controller to provide the processing for the RAID storage management functions. Often the RAID storage controller is implemented as a host bus adapter (HBA) operable within a host system (e.g., a computing system such as a workstation, server, or personal computer) attached to the storage devices. In other configurations, the RAID storage controller may be integral within a RAID storage subsystem and is thus not associated with any one attached host system. In both configurations, the RAID storage controller represents an additional hardware component comprising substantial processing capability. A RAID controller may is typically a relatively costly component and may be prohibitively so in a smaller RAID configuration.

Further, a RAID controller adapted to provide RAID storage management for a plurality of storage devices presents a single point of failure. Thus, where high reliability is critical to an application, multiple, redundant RAID storage controllers may be required to provide the desired level of reliability. Such redundant storage controllers add still further cost and complexity in smaller RAID configurations.

Thus, it is an ongoing challenge to provide cost effective performance and reliability improvements of RAID storage management in smaller environments.

### SUMMARY

The present invention solves the above and other problems, thereby advancing the state of the useful arts, by providing methods, apparatus, and systems for distributing RAID storage management into one or more SAS expanders in a SAS domain. SAS storage configurations have become popular to provide flexibility and scalability in storage systems. In most SAS storage environments, one or more SAS expanders are present to provide a switched fabric connection between any host system and one or more storage devices. SAS expanders already provide substantial computational capabilities that may be often underutilized—especially in smaller storage application environments. Methods and structures hereof utilize the processing capabilities of SAS expanders to provide distributed RAID storage management capabilities. SAS expanders enhanced in accordance with features and aspects hereof include RAID storage management processing capabilities to permit RAID storage management functions to be performed within one or more SAS expanders. Where multiple SAS expanders cooperate in the RAID storage management of a particular RAID logical volume, the multiple SAS expanders communicate and cooperate such that each expander provides a portion of the RAID storage management functionality.

One aspect hereof provides a SAS expander that includes a first interface for coupling the expander with another SAS device, a second interface for coupling the expander with another SAS expander, and a third interface for coupling the expander with one or more storage devices. The expander also includes a routing circuit coupled with the first and second interfaces. The routing circuit is adapted to receive a SAS frame through the first interface from another SAS device. The SAS frame includes a destination SAS address and the routing circuit is further adapted to selectively forward the SAS frame to another SAS expander through the second interface based on the destination SAS address. The expander also includes a RAID circuit coupled with the third interface and coupled with the routing circuit. The RAID circuit is adapted to receive the SAS frame from another SAS device through the routing circuit and the first interface. The destination address of the SAS frame is associated with a RAID logical volume that comprises a portion of each of the one or more storage devices. The SAS frame comprises a portion of an I/O request directed to the RAID logical volume and the RAID circuit is further adapted to process the portion of the I/O request by communicating with the one or more storage devices through the third interface.

A second aspect hereof provides a system that includes a plurality of SAS expanders where each of the plurality of SAS expanders is communicatively coupled with at least one other of the plurality of SAS expanders and where at least one of the SAS expanders is adapted for coupling with a SAS initiator. The system also includes a plurality of storage devices where each of the plurality of storage devices is communicatively coupled with at least one of the plurality of SAS expanders and where a RAID logic volume is stored on a portion of each of the plurality of storage devices. The RAID logical volume is identified by a destination SAS address. Each of the plurality of SAS expanders includes a RAID circuit adapted to receive a SAS frame generated by the SAS initiator. The SAS frame comprises a destination SAS address of the RAID logical volume. The RAID circuit is further adapted to process a portion of an I/O request from the SAS initiator within the SAS frame by communicating I/O operations with one or more of the plurality of storage devices coupled to each SAS expander. Each expander also includes a routing circuit adapted to selectively forward the received SAS frame to at least one other SAS expander of the plurality of SAS expanders.

Yet another aspect hereof provides a method operable in a SAS expander for processing I/O requests. The method includes receiving a SAS frame in the SAS expander from a SAS initiator. The SAS frame comprises a destination SAS address. The method also includes selectively forwarding the SAS frame to another SAS expander based on the destination SAS address and determining from the destination SAS address that the SAS frame comprises an I/O request directed to a RAID logical volume. The RAID logical volume comprises at least a portion of each of multiple storage devices, where at least one storage device of the multiple storage devices is coupled to the SAS expander. The method also includes communicating with the at least one storage device to process a portion of the I/O request within the SAS expander.

### BRIEF DESCRIPTION OF THE DRAWINGS

FIG. 1 is a block diagram of an exemplary RAID capable SAS expander enhanced in accordance with features and aspects hereof.

FIG. 2 is a block diagram of an exemplary system providing a plurality of enhanced SAS expanders of FIG. 1 cooperating to provide distributed RAID storage management in accordance with features and aspects hereof.

FIG. 3 is a diagram describing exemplary data flow among the plurality of enhanced SAS expanders of FIG. 2 in accordance with features and aspects hereof.

FIGS. 4 through 6 are flowcharts describing exemplary methods operable to provide RAID storage management in one or more enhanced SAS expanders in accordance with features and aspects hereof.

### DETAILED DESCRIPTION OF THE DRAWINGS

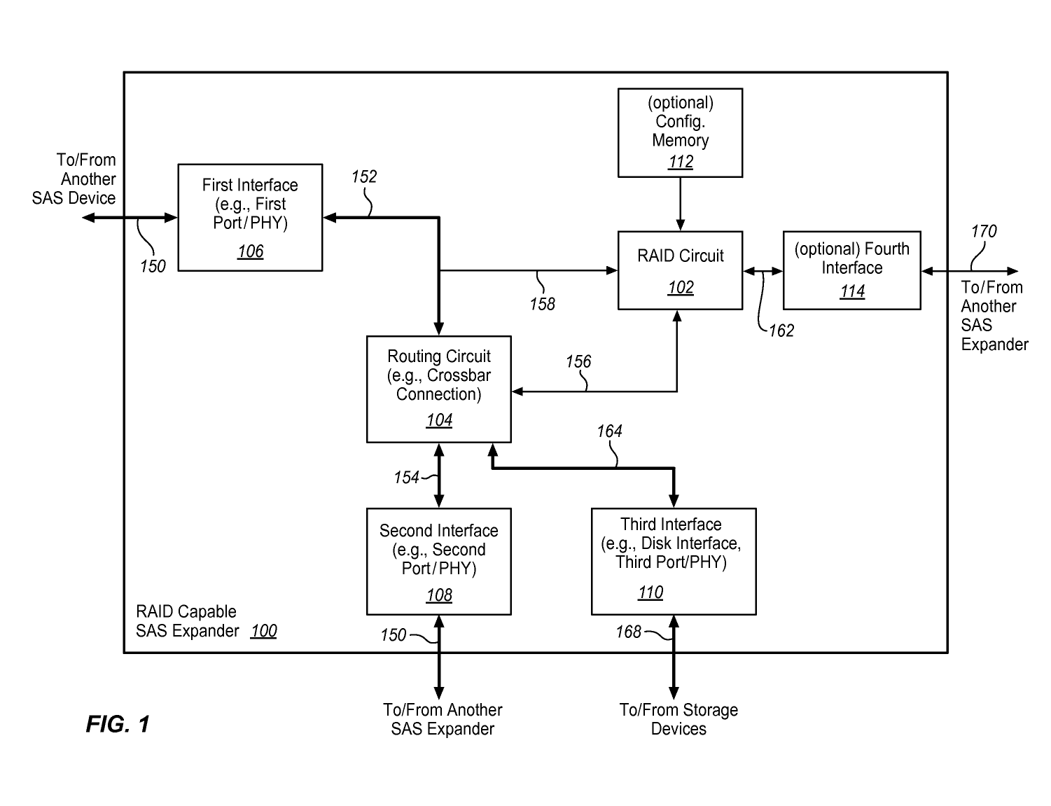

FIG. 1 is a block diagram of a SAS expander 100 enhanced in accordance with features and aspects hereof to provide for RAID storage management. SAS expander 100 includes routing circuit 104. Routing circuit 104 may be implemented as a standard crossbar connection circuitry (e.g., crossbar switching circuits) as is typical of many commercially available SAS expanders. SAS expander 100 may also include a first interface 106 for coupling SAS expander 100 with another SAS device (not shown). In one exemplary embodiment, first interface 106 may be a first port or PHY of the SAS expander adapted for coupling the expander with a SAS initiator and/or with another SAS expander of a SAS domain. SAS expander 100 may also include second interface 108 for coupling the SAS expander with another SAS expander of the SAS domain. In one exemplary embodiment, second interface 108 may be a second port or PHY of SAS expander 100 adapted for coupling the expander with another SAS expander of the SAS domain. Still further, SAS expander 100 may include third interface 110 which, in one exemplary embodiment, may be a third port or PHY of the SAS expander adapted for coupling SAS expander to one or more SAS or a SATA compatible storage devices.

Routing circuit 104 and multiple ports or PHYs (interfaces 106, 108, and 110) couple the SAS expander with one or more other SAS devices and with one or more storage devices in a SAS based storage system. Standard communication paths of SAS expander 100 are emphasized by thicker arrows coupling components 104 through 110. Specifically, first interface 106 may be coupled to another SAS device external to SAS expander 100 via path 150 and may be coupled to the routing circuit 104 via path 152. In like manner, second interface 108 may couple expander 100 to another SAS expander via path 150 and is coupled with routing circuit 104 via path 154. Still further, third interface 110 couples expander 100 to one or more storage devices via path 168 and is coupled to routing circuit 104 via path 164.

In accordance with features and aspects hereof, SAS expander 100 is enhanced for RAID storage management capability by the addition of RAID circuit 102. RAID circuit 102 may be implemented as a general or special purpose processor executing instructions suitably programmed for performing RAID storage management. In other exemplary embodiments, RAID circuit 102 may be implemented as a special purpose customized circuit designed specifically for RAID storage management processing capabilities. RAID circuit 102 is adapted to “snoop” (e.g., monitor) SAS frames received through first interface 106 and applied to the routing circuit 104 via path 152. In one exemplary embodiment, RAID circuit 102 passively monitors information on path 152 via its snooping path 158.

RAID circuit 102 detects when a frame is received by SAS expander 100 (snooped on path 152 via path 158). Based on the destination address in the SAS frame, RAID circuit 102 may determine whether the SAS frame is directed to a RAID logical volume managed by SAS expander 100. Optional configuration memory 112 may be preprogrammed to provide information identifying the RAID logical volume to be managed by RAID circuit 102. The preprogrammed information in configuration memory 112 may be initially provided by any suitable administrative user and interface (not shown) that configures RAID logical volumes to be utilized in a particular enterprise. The information in configuration memory 112 may define, for example, the geometry and configuration of the RAID logical volume to be managed by RAID circuit 102. Further, as discussed herein below, SAS expander 100 may manage a RAID logical volume by cooperating with other similarly capable SAS expanders of a SAS domain. In such an environment where multiple SAS expanders cooperate to manage a RAID logical volume, configuration memory 112 may include information defining a “RAID set”. The RAID set may define not only the geometry and configuration of one or more RAID logical volumes but may also identify all SAS expanders used cooperatively to manage each defined RAID logical volume.

When RAID circuit 102 detects receipt of a SAS frame destined for a RAID logical volume to be managed by expander 100, RAID circuit 102 determines what, if any, portions of an I/O request are represented by the received frame. If any portion of an I/O request represented by the received frame affects portions of the storage devices coupled to the expander 100, RAID circuit 102 processes those portions accordingly by communicating with affected storage devices coupled to SAS expander 100 through third interface 110. Specifically, as generally known in the art, a RAID logical volume may comprise portions of multiple storage devices mapped in such a manner that performance and/or reliability of the RAID logical volume is enhanced as compared to that of a single, stand-alone storage device. The geometry information accessible by RAID circuit 102 (e.g., from configuration memory 112) may be used to determine what portion of the RAID logical volume managed by expander 100 is affected by an I/O request represented by the received SAS frame. In one exemplary embodiment, RAID circuit 102 interacts with routing circuit 104 via path 156 to direct I/O operations to storage devices coupled to the expander through third interface 110 and paths 164 and 168.

In one exemplary embodiment, multiple SAS expanders may cooperate to manage a particular RAID logical volume. As noted above, the RAID set information (e.g., defined and stored in configuration memory 112) may identify the set of SAS expanders intended to cooperatively manage a corresponding, identified RAID logical volume. Thus, each of the multiple SAS expanders may be coupled with one or more of the storage devices, portions of which comprise a particular RAID logical volume. In such an environment, RAID circuit 102 of expander 100 may be further adapted to communicate with similar RAID circuits in other SAS expanders, as defined in the RAID set configuration information, to cooperatively manage a particular RAID logical volume (e.g., via second interface 108, routing circuit 104, and paths 156, 154, and 150). In another exemplary embodiment, RAID circuit 102 may communicate with RAID circuits in other SAS expanders through a dedicated communication path outside of the normal SAS domain. For example, fourth interface 114 may be coupled with RAID circuit 102 via path 162 and coupled with similar interfaces in other RAID circuits in other SAS expanders via path 170. Fourth interface 114 and path 170 may be implemented as, for example, one of, Ethernet, Fibre Channel, InfiniBand, etc. It may be desirable to utilize a dedicated channel (e.g., interface 114 and path 170) for such cooperative RAID management to reduce utilization of the SAS domain bandwidth for any overhead communications among the RAID circuits of the cooperating SAS expanders. Algorithms and methods operable within SAS expander 100 are discussed further herein below.

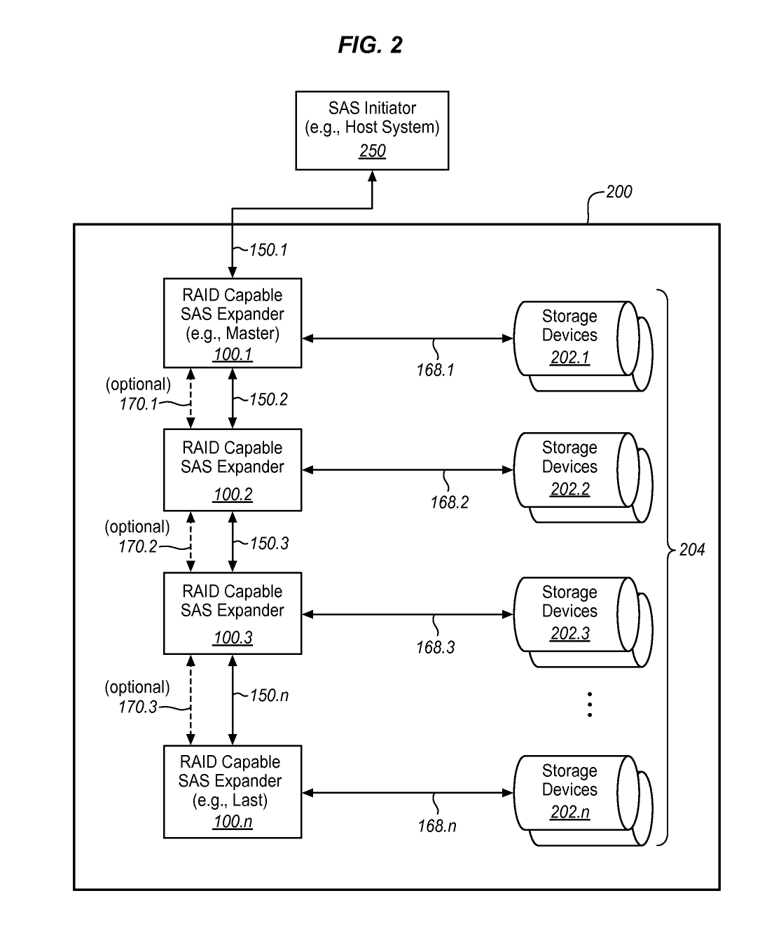

FIG. 2 is a block diagram showing an exemplary system 200 in which a plurality of SAS expanders (e.g., 100.1 through 100.n) are operable to provide RAID management of a RAID logical volume 204 stored on portions of multiple storage devices 202.1 through 202.n. System 200 may be coupled with a SAS initiator 250 (e.g., a host system or host bus adapter associated with a host system). Each SAS expander (100.1 through 100.n) may be implemented as described in FIG. 1 above to provide RAID storage management capabilities. As noted above, “RAID set” configuration information may identify the set of SAS expanders 100.1 through 100.n in the SAS domain responsible for cooperative management of the RAID logical volume 204. The RAID set configuration information may be stored in a configuration memory 112 of each SAS expander or otherwise made accessible to each of the expanders.

As identified in the RAID set information, one of the plurality of SAS expanders may be designated a master SAS expander (e.g., expander 100.1) with respect to an associated RAID logical volume. In one exemplary embodiment, the master SAS expander 100.1 may be the first SAS expander coupled with the SAS initiator 250 to initially receive a SAS frame representing an I/O request to the managed RAID logical volume. It will be understood by those of ordinary skill in the art that the master SAS expander need not necessarily be physically or electronically “closest” to the SAS initiator. Rather, the master expander is logically the first expander of the cooperative expanders (100.1 through 100.n) to receive a SAS frame from initiator 250 directed to a corresponding RAID logical volume.

In one exemplary embodiment, the master expander (100.1) serves as a controller in that it maintains and updates a record of resources used and available in each of the SAS expanders (100.1 through 100.n) in each RAID set managed by the master expander. The resource information may be stored in any suitable memory (volatile or non-volatile) within the master expander and may be updated as needed or periodically by communications exchanged among the expanders. Such exchanges could be performed over the dedicated communication path (170.x) if present or could be performed over the SAS communication paths coupling all expanders and the host system (150.x). In the latter case, the communications to maintain and update the resource records is preferably performed as out of band communications or SAS Management Protocol (SMP) exchanges to avoid confusion with of user data. The resources used in each expander may comprise buffer memory and/or computational resource used to constructing appropriate I/O operations and/or for performing RAID management address mapping and redundancy calculations.

Each SAS expander 100.1 through 100.n is coupled to at least one neighboring SAS expander in the cascading sequence by corresponding ports/PHYs and communication paths 150.1 through 150.n. As noted above, in one optional embodiment, each SAS expander 100.1 through 100.n may include an additional interface dedicated to communications among the RAID control circuits of each of the SAS expanders. Optional communication paths 170.1 through 170.3 represent such an additional communication path coupled to the optional dedicated interface within each SAS expander (e.g., 114 of FIG. 1). Further, each SAS expander 100.1 through 100.n is coupled with corresponding set of storage devices 202.1 through 202.n, respectively, via corresponding communication paths 168.1 through 168.n. It will be recognized by those of ordinary skill in the art that any number of storage devices 202 may be coupled with each SAS expander 100. In addition, it will be recognized that some storage devices may be coupled with more than one SAS expander to provide alternate or redundant paths to various storage devices. In accordance with the RAID set configuration information (e.g., stored within a configuration memory of each SAS expander) each storage device 202 is logically associated with a particular SAS expander for purposes of RAID storage management interaction though it may be physically/electronically coupled with any number of the SAS expanders. Thus, each SAS expander 100.1 through 100.n is configured by the RAID set configuration information to be responsible for a corresponding portion of a RAID logical volume distributed over the plurality of storage devices 202.1 through 202.n.

As one of the plurality of SAS expanders (e.g., 100.1) is designated as the master SAS expander, so too another of the plurality of SAS expanders is designated as the last SAS expander in the cascading sequence of expanders (e.g., SAS expander 100.n). The master expander (e.g., 100.1) and the last expander (e.g., 100.n) may each determine their respective status by reference to the configuration memory within each SAS expander storing the RAID set configuration information.

In operation of system 200, the master SAS expander 100.1 is the first of the plurality of SAS expanders (100.1 through 100.n) to detect reception of a SAS OPEN frame directed to a destination address associated with a RAID logical volume managed by the SAS expanders. The master SAS expander may detect the destination SAS address as associated with a RAID logical volume by referencing the configuration memory containing the RAID set configuration information. Upon detecting receipt of the SAS OPEN frame, the master expander (100.1) first determines whether sufficient resources are presently available in all expanders of the RAID set to permit establishment of the requested connection. If the master expander determines that sufficient resources are not presently available to establish the requested connection, the request may be rejected by return of an OPEN REJECT to the host system.

If sufficient resources are available in all expanders of the RAID set, the OPEN frame is forwarded to each expander of the cascading expanders. The master SAS expander forwards the SAS OPEN frame to a next SAS expander in the cascading sequence (e.g., 100.2). Each successive SAS expander in the cascading sequence similarly recognizes the SAS OPEN frame, reserves its required resources, and forwards the OPEN frame to a next SAS expander until the last SAS expander (e.g., 100.n) receives the SAS OPEN frame. The last SAS expander 100.n reserves its required resources and completes establishment of the connection with the identified RAID logical volume by returning a SAS OPEN ACCEPT frame up to the preceding SAS expander in the cascading sequence. The SAS OPEN ACCEPT frame is then returned to the master expander (100.1 via each of the SAS expanders of the cascading sequence). The master expander, in turn, returns the SAS OPEN ACCEPT frame to the SAS initiator 250 to complete establishment of the connection between the host system and the RAID set.

Responsive to receipt of the SAS OPEN ACCEPT frame, SAS initiator 250 commences transfer of SAS frames comprising command and/or data information relating to an I/O request directed to the RAID logical volume. Each such received command and/or data SAS frame is first received by the master SAS expander 100.1 and forwarded through each of the cascading sequence of SAS expanders. Each of the plurality of SAS expanders recognizes the receipt of the I/O request command and/or data SAS frames and determines what, if any, portions of the received I/O request command and/or data SAS frames affect any portions of storage devices coupled with each SAS expander. In other words, SAS expander 100.1 determines whether any portion of the I/O request command and/or data SAS frames affects any portion of storage devices 202.1. A request (or portion of a request) affects a storage device (or portion of a storage device) if it requires reading or writing of data from or to the storage device. In like manner, SAS expander 100.2 determines whether any portion of the I/O request command and/or data SAS frames affects any portion of storage devices to a 202.2, etc.

Responsive to a determination that some portion of an I/O request command and/or data SAS frame affects some portion of the storage devices coupled to a SAS expander, the SAS expander performs appropriate I/O operations on its respective storage devices to thereby process its portion of the I/O request. In particular, each SAS expander of the plurality of SAS expanders performs appropriate RAID storage management computations to read and/or write any portions of the I/O request that affect the storage devices coupled to that SAS expander.

Each SAS expander generates status information regarding its RAID operations corresponding to its portions of the I/O request. All such status information is returned from each SAS expander to its preceding expander in the cascading sequence of SAS expanders. The master expander 101.1 ultimately receives the returned status information from each of the succeeding expanders in the cascading sequence. Master SAS expander 100.1 aggregates all the received status information from other SAS expanders (as well as that of its own RAID operations) and returns an aggregated completion status to the SAS initiator 250 to thereby complete the I/O request. The status information is aggregated in that if any of the expanders indicate a failure of its operations, the aggregated status indicates a failure of the entire I/O request. Only if all expanders successfully complete their respective operations is a successful aggregated status returned for an I/O request.

The crossbar connection/switching features of routing circuit 104 of expander 100 of FIG. 1 typically incorporates a memory for storing dynamically determined routing information to map a destination address to a corresponding port/PHY of the expander. Further, the routing logic typically includes programmable logic (e.g., a CPU) for controlling operation of the routing circuits in accordance with the routing information. Such additional elements are well known to those of ordinary skill in the art and present in most commercially available expanders to provide standard functionality of the expander. Those of ordinary skill in the art will readily recognize these and other additional and equivalent components and modules within a fully functional system 200 of FIG. 2 and a fully functional expander 100 of FIGS. 1 and 2. Such well-known additional and equivalent elements are omitted herein for brevity and simplicity of this discussion.

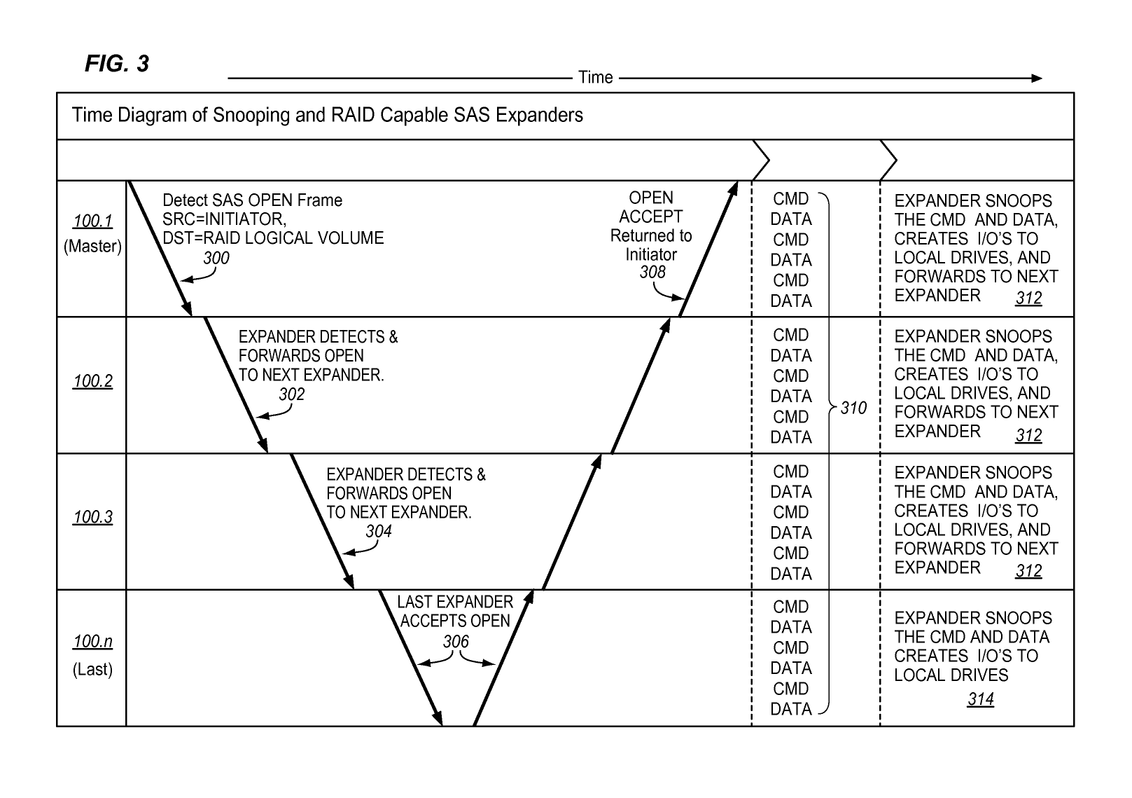

FIG. 3 generally provides additional details of data flow as discussed above with respect to operation of the system 200 of FIG. 2. In FIG. 3, time advances from the left side of the figure to the right. Operation of a first expander 100.1 is described with reference to a row extending from the left side label for an expander's data flow (e.g., a row labeled 100.1 at the left extending to the right, a row labeled 100.2 at the left extending to the right, etc.).

Expander 100.1 (e.g., the master SAS expander) first receives an OPEN frame from a SAS initiator as indicated by arrow 300. The master expander 100.1 determines, based on the destination address in the frame, that the OPEN frame is directed to a RAID logical volume defined in the configuration information in the RAID set configuration memory. Responsive to the determination, the received SAS OPEN frame is forwarded to a next expander in the cascading sequence—namely, expander 100.2. Expander 100.2 and expander 100.3 each, in turn, detect receipt of the OPEN frame, determine that it is addressed to a RAID logical volume, and forward the OPEN frame to a next expander of the cascading sequence as indicated by arrows 302 and 304, respectively. The last expander 100.n receives the forwarded SAS OPEN frame and, responsive to determining that the OPEN frame is addressed to a RAID logical volume, generates a corresponding SAS OPEN ACCEPT frame as indicated by arrows 306. The SAS OPEN ACCEPT frame so generated is then returned in a similar forwarding manner through the cascading sequence of SAS expanders up to the master SAS expander 100.1. Master SAS expander 100.1 then returns the OPEN ACCEPT frame to the SAS initiator as indicated by arrow 308. The OPEN ACCEPT frame is generally returned only if each expander in the cascading sequence determines that its storage devices required for access to the RAID volume are available for the requested connection to be opened. If not, an OPEN REJECT frame may be returned in accordance with standard SAS protocols.

Following receipt of the OPEN ACCEPT frame by the SAS initiator, the initiator sends a sequence of command and/or data SAS frames collectively identified as reference number 310. The collection of command and/or data frames represent an I/O request directed to the identified RAID logical volume as defined in the configuration information of the RAID set. Master SAS expander 100.1 first receives each of the sequence of command and/or data frames from the SAS initiator. Each expander “snoops” (e.g., monitors to detect) each of the received command and/or data frames to detect the presence of the RAID logical volume destination SAS address in each snooped frame.

In particular, the master SAS expander, responsive to detecting the RAID logical volume destination address in a snooped frame, creates appropriate I/O operations to storage devices locally attached to the master SAS expander and simultaneously forwards received command and/or data frame to a next SAS expander in the cascading sequence. Such processing is indicated by reference number 312 in the rightmost box of the row corresponding to master SAS expander 100.1. Each of the other SAS expanders, in turn, receives the forwarded command and/or data frames (310) forwarded from a preceding SAS expander. Responsive to detecting the RAID logical volume address in each snooped frame, each successive expander generates appropriate I/O operations and forwards the command and/or data frames to a next SAS expander in the cascading sequence. For all but the last expander (100.n), this processing is represented by reference number 312 in rightmost box of the row of each other expander. The last SAS expander (100.n) detects that it is the last expander in the cascading sequence (based on the configuration information in the RAID set) and therefore need not forward the command and/or data frames to any other expander. Last expander 100.n therefore need only generate appropriate I/O operations to portions of its storage devices affected by any portion of the I/O request represented in the received command and/or data frame (as indicated by reference number 314).

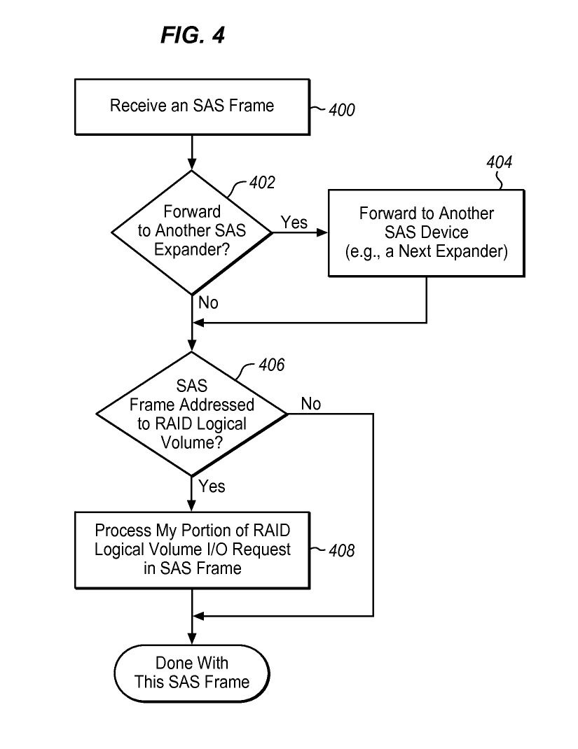

FIG. 4 is a flowchart describing an exemplary method in accordance with features and aspects hereof operable in an enhanced SAS expander such as expander 100 of FIG. 1 (and/or in each of the expanders 100.1 through 100.n of FIG. 2).

The method of FIG. 4 is operable at step 400 in response to receipt of a SAS frame. Step 402 determines, based on the destination address of the received frame, whether the frame is to be routed (e.g., forwarded) to another SAS device/expander. If so, step 404 forwards the received SAS frame to an appropriate other SAS device/expander of the SAS domain. In either case, processing then continues at step 406 as described below. The processing steps 402 and 404 are generally performed by routing circuitry (e.g., crossbar circuitry or crossbar switching circuits) generally present in any SAS expander as well known to those of ordinary skill in the art.

In step 406, the enhanced SAS expander detects specifically whether the received SAS frame is addressed to a RAID logical volume managed (at least in part) by this expander. As noted above, to make this determination, an enhanced SAS expander may inspect configuration information regarding a RAID set to determine the destination address of the RAID logical volume. A RAID set may define a particular RAID logical volume to be managed by a plurality of SAS expanders and may identify the particular SAS expanders used for managing the RAID volume. The RAID set configuration information may also include, for example, detailed geometry and configuration information regarding the layout of the identified RAID logical volume. If step 406 determines that the SAS frame is not addressed to a RAID logical volume managed by this SAS expander, the method is complete as regards the processing of this SAS frame and the frame has been appropriately forwarded to a next SAS device/expander as indicated above at step 404.

If step 406 determines that the received SAS frame is addressed to a RAID logical volume managed (at least in part) by this SAS expander, step 408 processes any portion of the I/O request represented by the received SAS frame that affects storage devices coupled with this SAS expander. As noted above, the SAS frame may include a SAS OPEN, a SAS OPEN ACCEPT, a SAS OPEN REJECT, and/or various other SAS frames comprising command and/or data associated with an I/O request. Each such frame is processed appropriately in step 408 including any and all computations associated with the RAID storage management of the RAID logical volume.

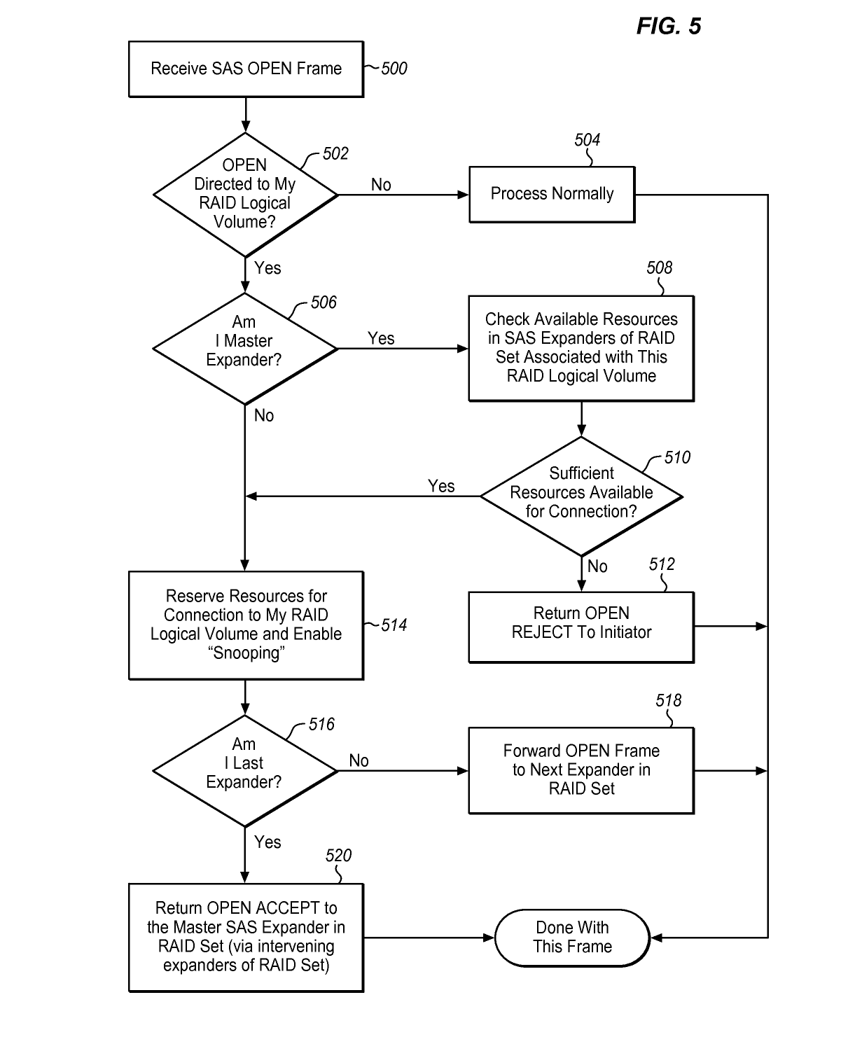

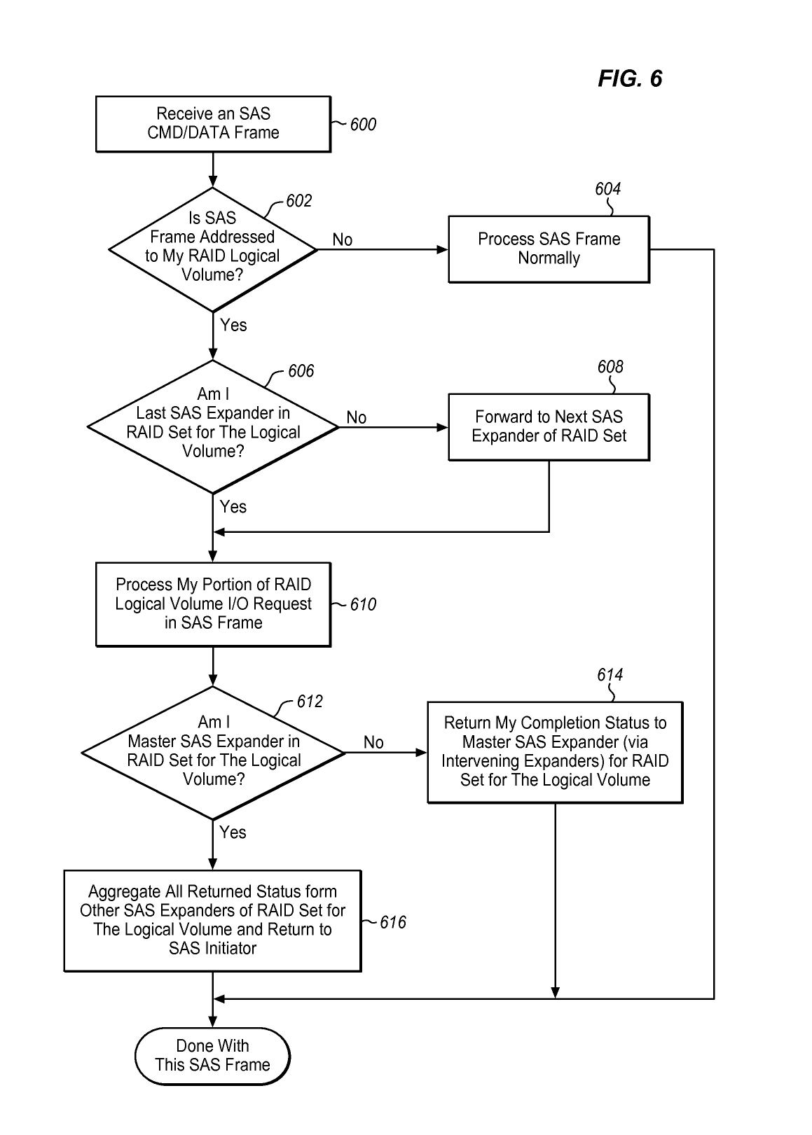

FIGS. 5 and 6 are flowcharts describing other exemplary methods operable in, for example, system 200 of FIG. 2 (and thus operable in each of a plurality of SAS expanders 100.1 through 100.n as described in FIGS. 1 and 2).

In particular, FIG. 5 describes a method operable in a SAS expander responsive to receipt of a SAS OPEN frame as indicated at step 500. Step 502 then determines, based on the destination address of the frame, whether the received OPEN frame is directed to a RAID logical volume managed (at least in part) by this SAS expander (the expander performing this method). As noted above, such a determination may be made with reference to configuration information contained in the RAID set typically stored within each SAS expander of the system. If step 502 determines that the OPEN frame is not directed to a RAID logical volume managed by this expander, step 504 represents all normal processing for a SAS OPEN frame within the standard SAS protocols thus completing the method of FIG. 5.

If step 502 determines that the received OPEN frame is directed to a RAID logical volume managed by this expander, step 506 next whether this expander (the expander performing this method in response to receipt of the OPEN) is the master expander of the plurality of expanders in the RAID set associated with the addressed RAID logical volume. If this expander is the master expander of the RAID set, step 508 next determines whether there are sufficient resources available in the expanders of the RAID set to allow the requested open connection to the addressed RAID logical volume. The master expander may maintain information regarding the available resources in each of the expanders of the RAID set associated with the addressed RAID logical volume. As noted above, in one exemplary embodiment this resource information may be stored in a suitable memory associated with the master expander. Periodic updates of the available resources may be exchanged among the expanders as SAS SMP frames and/or as out of band communication signals. The resources to be monitored and checked for availability may include buffer memory used in the expanders of the RAID set to snoop and process portions of RAID I/O request. Further, it will be noted that any single expander could be a participant in one or more RAID sets. Thus, resource information regarding changes and availability may be periodically exchanged among all of the expanders in a SAS domain or may be changed only when there is a change in resource availability. Step 510 then determines whether the resources available as checked by step 508 are sufficient to permit the requested open connection. If not, step 512 returns an appropriate OPEN REJECT to the requesting SAS initiator. In one embodiment, the OPEN REJECT may indicate that the requested connection is busy and that it may be retried later.

If step 506 determines that this expander is not the master expander or if step 510 determines within the master expander that sufficient resources are available within expanders of the RAID set of the addressed RAID logical volume, processing continues at step 514. Step 514 reserves the resources within this expander needed for processing portions of RAID I/O requests. Step 514 also configures this expander to commence “snooping” of received frames within this expander to detect receipt of command and/or data frames addressed to the RAID logical volume represented by the RAID set.

Step 516 next determines whether this expander is the last expander of the RAID set associated with the addressed RAID logical volume. As noted above, such a check may be made by reference to the configuration memory within each expander that defines the RAID set associated with each RAID logical volume. If this expander is not the last expander for the RAID set of the addressed RAID logical volume, step 518 forwards the received OPEN frame to the next expander of the RAID set associated with the addressed RAID logical volume. If this expander is the last expander of the RAID set, step 520 returns and OPEN ACCEPT to the master SAS expander of the RAID set associated with the addressed RAID logical volume (returned through each of the intervening expanders of the RAID set, if any).

In one simple embodiment where a single expander is defined in the RAID set for an addressed RAID logical volume, the single expander is conceptually both the master and the last expander in the context of the method of FIG. 5. Those of ordinary skill in the art will readily recognize modification to the method of FIG. 5 in the case of a single expander managing a RAID logical volume.

Assuming an appropriate connection is established with an identified RAID logical volume by the processing of FIG. 5 above, FIG. 6 is a flowchart describing a method for processing subsequently received command/data frames from the SAS initiator. In general, processing by the method of FIG. 6 commences at step 600 with receipt of a SAS command/data frame. Step 602 then determines whether the received frame is addressed to a RAID logical volume managed (at least in part) by this expander. If not, step 604 represents all other normal processing of the SAS frame in accordance with standard SAS protocols within a SAS expander. If step 602 determines that the received command/data frame is addressed to one of this expander's RAID logical volumes, step 606 determines whether this expander is the last expander in the cascading sequence of expanders defined in the RAID set for the identified RAID logical volume. If not, step 608 forwards the received frame to the next expander of the cascading sequence defined by the RAID set. In both cases, processing continues at step 610.

Step 610 represents processing by the SAS expander to perform appropriate I/O operations based on a portion of the I/O request received in the command/data frame that affects any portion of the local storage devices coupled with this SAS expander. As noted above, processing in step 610 includes any RAID related computations and/or I/O operations directed to the storage devices coupled with this expander.

Following completion of the RAID management functions and/or I/O operations of step 610, step 612 determines whether this expander is the master SAS expander in the cascading sequence of expanders defined by the RAID set for this RAID logical volume. If not, step 614 returns the completion status of the I/O operations and RAID management processing perform at step 610 to a preceding SAS expander of the cascading sequence of expanders defined by the RAID set for this logical volume. The completion status so returned is eventually forwarded to the master expander for further processing. If step 612 determines that this expander is the master expander for the RAID set of this RAID logical volume, step 616 performs I/O request completion processing associated with the master SAS expander to aggregate the returned completion status from all other SAS expanders of the RAID set for this RAID logical volume. Once a completion status is received from each of the other SAS expanders in the RAID set, the master SAS expander returns the aggregated completion status to the SAS initiator to thereby complete the I/O request processing.

The methods of FIGS. 4, 5, and 6 may be implemented, as a matter of design choice, as custom electronic circuitry to process received SAS frames and/or as suitably programmed instructions executed by an appropriate general or special purpose processor within enhanced SAS expanders. Various additional and equivalent method steps will be readily apparent to those of ordinary skill in the art in review of the method described by the flowcharts of FIGS. 4 through 6. Such additional and equivalent method steps are omitted herein for simplicity and brevity of this discussion.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A Serial Attached SCSI (SAS) expander comprising:
a first interface for coupling the expander with another SAS device;
a second interface for coupling the expander with another SAS expander;
a third interface for coupling the expander with one or more storage devices;
a routing circuit coupled with the first and second interfaces, the routing circuit adapted to receive a SAS frame through the first interface from said another SAS device, the SAS frame comprising a destination SAS address, the routing circuit further adapted to selectively forward the SAS frame to said another SAS expander through the second interface based on the destination SAS address; and
a Redundant Array of Independent Disks (RAID) circuit coupled with the routing circuit, the RAID circuit adapted to receive the SAS frame from said another SAS device through the routing circuit and the first interface, the destination address of the SAS frame is associated with a RAID logical volume that comprises a portion of each of the one or more storage devices, the SAS frame comprising a portion of an I/O request directed to the RAID logical volume, the RAID circuit further adapted to process the portion of the I/O request by communicating with the one or more storage devices through the routing circuit and the third interface.

2. The expander of claim 1 further comprising:
wherein said another SAS expander comprises another RAID circuit,
wherein the RAID circuit is further adapted to communicate with said another RAID circuit in said another SAS expander to share information regarding the received SAS frame, and
wherein the RAID circuit is further adapted to process the portion of the I/O request in cooperation with said another RAID circuit.

3. The expander of claim 2
wherein the RAID circuit in the SAS expander is adapted to communicate with said another RAID circuit in said another SAS expander through the second interface and the routing circuit.

4. The expander of claim 2 further comprising:
a fourth interface adapted to coupled the RAID circuit with said another SAS expander,
wherein the RAID circuit of the SAS expander is adapted to communicate with said another RAID circuit in said another SAS expander through the fourth interface.

5. The expander of claim 4
wherein the fourth interface is one of:
an Ethernet interface;
a Fibre Channel interface; or
an InfiniBand interface.

6. The expander of claim 1 further comprising:
a configuration memory adapted to store information regarding all SAS expanders in a RAID set associated with the RAID logical volume.

7. The expander of claim 6
wherein the SAS expander is determined to be a master SAS expander of the RAID set based on information in the configuration memory,
wherein the RAID circuit is further adapted to communicate with other SAS expander of the RAID set,
wherein said other SAS expanders process other portions of the I/O request directed to the RAID logical volume,
wherein the RAID circuit receives status information from said other SAS expanders regarding processing of said other portions, and
wherein the RAID circuit is further adapted to aggregate status information from all SAS expanders defined in the RAID set and is further adapted to return the aggregated status information to said another SAS device through said first interface.

8. The expander of claim 6
wherein the SAS expander is determined to be a last SAS expander of the RAID set based on information in the configuration memory,
wherein the routing circuit last SAS expander is further adapted to not forward the SAS frame to said another SAS expander.

9. The expander of claim 8
wherein the last SAS expander is further adapted to receive a SAS OPEN frame forwarded from another SAS expander of the RAID set, and
wherein the last SAS expander is further adapted to respond to the received SAS OPEN frame with a SAS OPEN ACCEPT frame.

10. A system comprising:
a plurality of Serial Attached SCSI (SAS) expanders wherein each of the plurality of SAS expanders is communicatively coupled with at least one other of the plurality of SAS expanders and wherein at least one of the SAS expanders is adapted for coupling with a SAS initiator; and
a plurality of storage devices wherein each of the plurality of storage devices is communicatively coupled with at least one of the plurality of SAS expanders, wherein a Redundant Array of Independent Disks (RAID) logic volume is stored on a portion of each of the plurality of storage devices, and wherein the RAID logical volume is identified by a destination SAS address;
wherein each of the plurality of SAS expanders comprises:
a RAID circuit adapted to receive a SAS frame generated by the SAS initiator, the SAS frame comprising a destination SAS address of the RAID logical volume, the RAID circuit further adapted to process a portion of an I/O request from the SAS initiator within the SAS frame by communicating I/O operations with one or more of the plurality of storage devices coupled to said each SAS expander; and
a routing circuit adapted to selectively forward the received SAS frame to at least one other SAS expander of the plurality of SAS expanders.

11. The system of claim 10
wherein each SAS expander further comprises:
a configuration memory adapted to store information regarding a RAID set that comprises information regarding the plurality of SAS expanders associated with the RAID logical volume.

12. The system of claim 11
wherein the configuration information comprises:
master identifier information designating one SAS expander as the master SAS expander and wherein the master SAS expander is coupled with the SAS initiator,
wherein the master expander is adapted to receive status information from each of the SAS expanders regarding processing of its respective portion of the I/O request and is further adapted to return completion status information to the SAS initiator regarding the I/O request to the SAS initiator based on the received status information from each of the plurality of SAS expanders comprising the RAID set.

13. The system of claim 11
wherein the configuration information comprises:
last expander identifier information designating one SAS expander as the last SAS expander,
wherein the routing circuit of the last SAS expander does not forward a received SAS frame to another SAS expander of the RAID set.

14. The system of claim 13
wherein the last SAS expander is further adapted to received a SAS OPEN frame from another SAS expander of the RAID set, and
wherein the last SAS expander is further adapted to return a SAS OPEN ACCEPT frame to said another SAS expander to be returned to the SAS initiator.

15. A method operable in a Serial Attached SCSI (SAS) expander for processing I/O requests, the method comprising:
receiving a SAS frame in the SAS expander from a SAS initiator, the SAS frame comprising a destination SAS address;
selectively forwarding the SAS frame to another SAS expander based on the destination SAS address;
determining from the destination SAS address that the SAS frame comprises an I/O request directed to a Redundant Array of Independent Disks (RAID) logical volume, the RAID logical volume comprising at least a portion of each of multiple storage devices, wherein at least one storage device of the multiple storage devices is coupled to the SAS expander; and
communicating with the at least one storage device to process a portion of the I/O request within the SAS expander.

16. The method of claim 15 further comprising:
determining from information in a configuration memory of the SAS expander that the SAS expander is a master SAS expander of a RAID set associated with the RAID logical volume, the RAID set comprising multiple SAS expanders.

17. The method of claim 16 further comprising:
receiving within the master SAS expander status information regarding processing of portions of the I/O request;
aggregating the received status information within the master SAS expander to generate a completion status for the I/O request; and
returning the generated completion status to the SAS initiator coupled with the master SAS expander.

18. The method of claim 15 further comprising:
determining from information in a configuration memory of the SAS expander whether the SAS expander is a last SAS expander of a RAID set associated with the RAID logical volume, the RAID set comprising multiple SAS expanders.

19. The method of claim 18
wherein the step of selectively forwarding further comprises:
forwarding the SAS frame only in response to a determination that the SAS expander is not the last SAS expander.
